(19) United States
(12) Patent Application Publication
(10) Pub. No.: US 2002/0104699 A1
(43) Pub. Date: Aug. 8, 2002

(54) Tilting mechanism for tilting a vehicle cab

(76) Inventor: Erwin Bernardus Johannes Damhuis, Hengelo (NL)

Correspondence Address: QUARLES & BRADY LLP, 411 E. WISCONSIN AVENUE, SUITE 2040, MILWAUKEE, WI, 53202-4497, US

(21) Appl. No.: 10/112,398

(22) Filed: Mar. 28, 2002

Related U.S. Application Data
(63) Continuation of application No. PCT/NL00/00724, filed on Oct. 6, 2000.

(30) Foreign Application Priority Data
Oct. 6, 1999 (NL) 1013228

(51) Int. Cl. B62D 33/067

(52) U.S. Cl. 180/89.14

(57) ABSTRACT

The invention relates to a tilting mechanism for making the cab of a vehicle tilt relative to the chassis of the vehicle. The tilting mechanism comprises at least one fixing part that during the fitting of the cab on the chassis goes into a permanent engagement with a fixing part fitted on the cab and/or the chassis.

### CROSS REFERENCE TO RELATED APPLICATION

This is a continuation application of PCT/NL00/0724 filed Oct. 6, 2000, which PCT application claims priority of Dutch patent application number 1013228 filed Oct. 6, 1999, herein incorporated by reference.

### FIELD OF THE INVENTION

The present invention relates to a tilting mechanism for making the cab of a vehicle tilt relative to the chassis of the vehicle, comprising: an extending and retracting actuator; a first coupling means, intended for coupling the actuator to the cab; and a second coupling means, intended for coupling the actuator to the chassis.

### BACKGROUND OF THE INVENTION

Tilting mechanisms for making a vehicle cab, for example the cab of a lorry, tilt are known.

Such a tilting mechanism generally comprises as the actuator a hydraulic piston/cylinder device in which the piston rod can be extended and retracted relative to the cylinder. The actuator is fitted between the chassis and the cab of a vehicle. The cylinder of the piston/cylinder device is usually pivotably fixed at its bottom end in a support on the chassis of the vehicle, and the piston rod of the piston/cylinder device is then pivotably fixed at its top end in a support on the underside of the cab of the vehicle.

Normally, during the assembly of the vehicle the fixing of the cylinder to the chassis and of the piston rod to the cab respectively is performed manually using a known bolt/pin connection such as that described in, for example, EP 0,429,757 B1.

In the assembly process of a lorry the piston/cylinder device is generally first fixed to the chassis, and the piston rod is fixed to the cab only at a later stage of the assembly. The fixing of the cylinder to the chassis is performed in a simple manner by fitting the said known bolt/pin connection between the bottom end of the cylinder and a support on the chassis. The positioning and mounting of the tilting driver's cab on the chassis are performed at a later stage of the assembly. In this case the piston rod is usually fixed to the cab by fitting said bolt/pin connection between the top end of the piston rod and a support on the underside of the cab.

For the fitting of the piston rod on the underside of the cab, in the case of the known assembly process the piston rod is pulled manually a bit out of the cylinder. However, this method has two major disadvantages:

1) the person pulling the piston rod a bit out of the cylinder must make a considerable physical effort in an awkward physical posture to do so, and

2) air is drawn into the piston/cylinder device while the piston rod is being pulled out of the cylinder, and this air subsequently has to be extracted from said device again.

The second disadvantage mentioned is particularly a disadvantage for the assembly process. The air has to be removed from the tilting mechanism after the latter has been fitted, for example by extending the piston rod by means of the hydraulic pump. This takes time and requires the deployment of an additional person, which makes the assembly process more complicated and more expensive.

The following can be mentioned as a third disadvantage:

3) the manual fitting of the piston rod on the cab is time-consuming. This means that the fitting of the piston rod can be a determining factor for the entire assembly process of the vehicle.

The object of the present invention is to provide a tilting mechanism that facilitates the fitting of the actuator between the chassis and the cab of a vehicle during the assembly process of the vehicle. This reduces the risk of health problems for the person carrying out the fitting, and the required fitting time and fitting costs are reduced.

### SUMMARY OF THE INVENTION

In order to achieve the abovementioned object, the present invention provides a tilting mechanism of the type described above, wherein at least one of the first coupling means and the second coupling means comprises a fixing means having a first fixing part and a second fixing part, the first fixing part and the second fixing part being designed to go into a permanent engagement with each other as a result of the first fixing part and the second fixing part being brought together during the assembly of the vehicle.

According to a preferred embodiment of the present invention, a support comprising a locking hook and a permanent blocking mechanism, for example a retaining pin, is fitted on the underside of the cab. The top end of the piston rod is provided with a projection and is positioned in such a way that said projection can be brought into engagement with the locking hook. The fitting of the piston rod on the cab then takes place automatically when the cab is moved in the direction of the chassis, by the fact that the projection and the locking hook engage with each other and the retaining pin subsequently fixes the locking hook in a specific position relative to the support, as a result of which a permanent coupling between the top end of the piston rod and the cab is produced.

It is pointed out that a tilting mechanism that is provided with a fixing part that can engage with another fixing part on the underside of the cab of a vehicle is known per se, for example from EP 0,520,587 A1. In the case of that tilting mechanism the fixing parts are brought into temporary engagement with each other when the cab has to be tilted relative to the chassis of the vehicle. Contrasting with this, when a tilting mechanism according to the present invention is used the fixing parts are brought once and permanently into engagement with each other, namely during the assembly of the vehicle.

The aspects already described and other aspects, features and advantages of the present invention will be explained in further detail in the description that follows of two preferred embodiments of a tilting mechanism according to the invention with reference to the drawing.

### BRIEF DESCRIPTION OF THE DRAWINGS

FIG. 1 shows a diagrammatic side view of a tilting mechanism according to the present invention fitted on the chassis of a vehicle before fitting on the cab of the vehicle;

FIG. 2 shows a diagrammatic side view of a tilting mechanism according to the present invention after fitting between the cab and the chassis of a vehicle;

FIG. 3 shows a diagrammatic side view of a first preferred embodiment of a tilting mechanism according to the present invention;

FIG. 4 shows a side view in cross section of a part of a second preferred embodiment of a tilting mechanism according to the present invention.

### DESCRIPTION OF THE PREFERRED EMBODIMENT

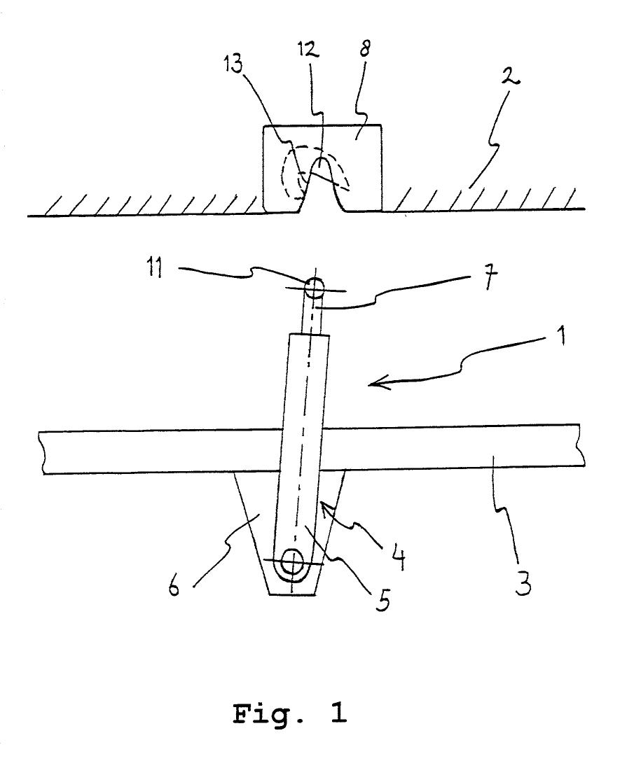

FIG. 1 shows a tilting mechanism 1 according to the present invention fitted on a chassis 3 of a vehicle before fitting on a cab 2 of the vehicle. A piston/cylinder device 4 is pivotably fixed to the chassis 3 at the bottom end of a cylinder 5 by way of a support 6, for example by means of a bolt/pin connection. The top end of a piston rod 7 comprises a projection 11. A support 8, comprising a locking hook 12, is provided on the underside of the cab 2. The support 8 also comprises a guide 13, which is shaped as a V-shaped recess in the support 8.

Before the fitting on the cab 2 of the tilting mechanism 1 fitted on the chassis 3, positioning means (not shown) can be placed near the tilting mechanism 1, in order to make correct positioning of the projection 11 relative to the guide 13 easier. When the cab 2 is subsequently moved in the direction of the chassis 3, the guide 13 slides over the projection 11 and forces the latter into the correct position to enable it to go into engagement with the locking hook 12. When the projection 11 and the locking hook 12 are in engagement with each other, the locking hook 12 is fixed in a locked position relative to the support 8, for example by a retaining pin which is connected to a (coil) spring.

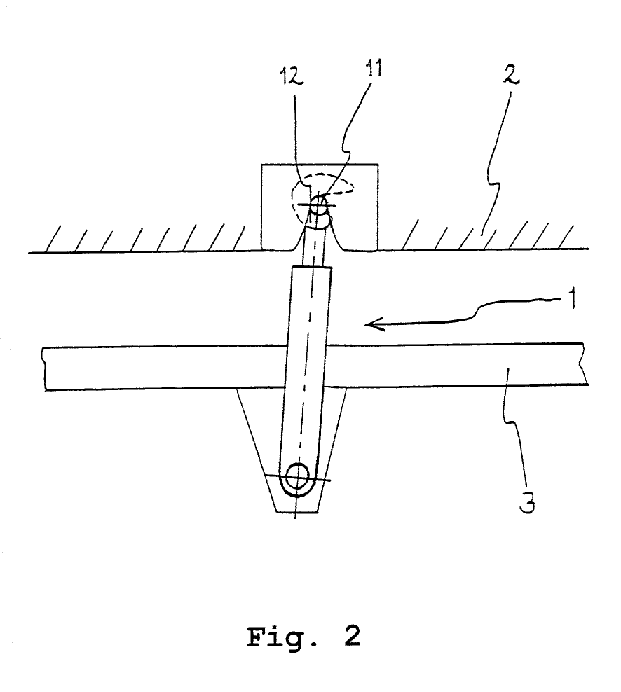

FIG. 2 shows the tilting mechanism 1 according to the present invention after it has been fitted between the cab 2 and the chassis 3. The projection 11 and the locking hook 12 are permanently and pivotably connected to each other in this position, for example by the fact that a retaining pin has fixed the locking hook 12 in a specific position, and the latter in turn encloses the projection 11 in a pivotable manner. After fitting, the positioning means (not shown) can be removed.

FIGS. 1 and 2 show a tilting mechanism 1 according to the present invention in the case of which the support 8 having the locking hook 12 is fitted on the underside of the cab 2. It is, however, also possible to provide the chassis 3 with such a support, so that the connection between the bottom end of the cylinder 5 and the chassis 3 can be performed in the manner described above, while the top end of the piston rod 7 and the cab 2 are fixed to each other, for example, by means of a bolt/pin connection. It is also possible to provide both the underside of the cab 2 and the chassis 3 with a support having a locking hook, so that the entire fitting of the tilting mechanism 1 between the cab 2 and the chassis 3 can be performed without the use of bolt/pin connections or the like.

In the description and the figures it is always assumed that the support 8 having the locking hook 12 is fitted on the cab 2 and/or the chassis 3, and the projection 11 on the piston rod 7 and/or the cylinder 5. However, it is also possible to provide the piston rod 7 and/or the cylinder 5 with the support 8 having the locking hook 12, and the cab 2 and/or the chassis 3 with the projection 11.

Within the scope of the present invention it is also possible to fit the tilting mechanism 1 between the cab 2 and the chassis 3 while the cab 2 is already on the chassis 3. For this purpose, the piston rod 7 is extended relative to the cylinder 5 using a hydraulic system by means of which the piston/cylinder device 4 is operated.

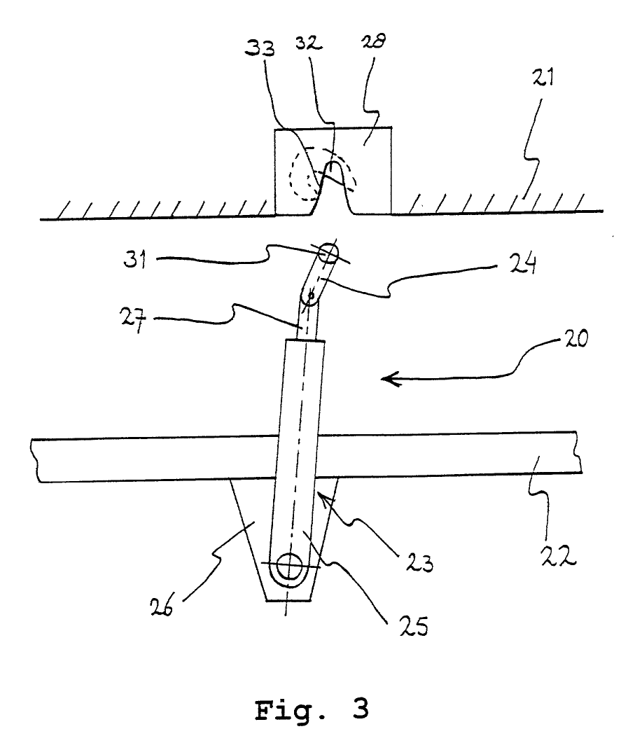

FIG. 3 shows a first preferred embodiment of a tilting mechanism 20 according to the present invention before fitting on a cab 21 of a vehicle. Said tilting mechanism 20 comprises a piston/cylinder device 23 and a lost-motion link 24. Such a lost-motion link is known per se, and is fitted in order to prevent the piston/cylinder device 23 of the tilting mechanism 20 from having an adverse effect on the riding comfort in the cab 21 while the vehicle is being driven, by preventing movements of the cab 21 from having a direct effect on the piston/cylinder device 23.

In the embodiment of the tilting mechanism 20 according to the present invention shown in FIG. 3 the piston/cylinder device 23 is pivotably fixed at the bottom end of a cylinder 25 by way of a support 26 to a chassis 22 of the vehicle. The piston/cylinder device 23 is pivotably connected at the top end of a piston rod 27 to one end of the lost-motion link 24. The other, free end of the lost-motion link 24 comprises a projection 31. A support 28, comprising a locking hook 32, is fitted on the underside of the cab 21. The support 28 also comprises a guide 33, which is shaped as a V-shaped recess in the support 28.

Before the tilting mechanism 20 is fitted on the cab 21, the piston/cylinder device 23 and the lost-motion link 24 can be taken by means of positioning means (not shown) into a position in which the projection 31 on the free end of the lost-motion link 24 can slide into the guide 33. When the cab 21 is subsequently moved in the direction of the chassis 22, the guide 33 slides over the projection 31 and forces the latter into the correct position to enable it to engage with the locking hook 32. When the projection 31 and the locking hook 32 are in engagement with each other the locking hook 32 is fixed in a certain position relative to the support 28, resulting in a permanent coupling between the projection 31 and the locking hook 32. After this coupling has been performed, the positioning means (not shown) can be removed.

In the first preferred embodiment of the tilting mechanism 20 according to the present invention described above a permanent connection is performed between the lost-motion link 24 and the cab 21 when the latter is moved in the direction of the chassis 22. The permanent connection could also be performed, for example, between one end of the lost-motion link 24 and the top end of the piston rod 27, the other end of the lost-motion link 24 being pivotably fixed by way of a support to the cab 21. The support 28 having the locking hook 32 is then fitted on one end of the lost-motion link 24 or on the top end of the piston rod 27.

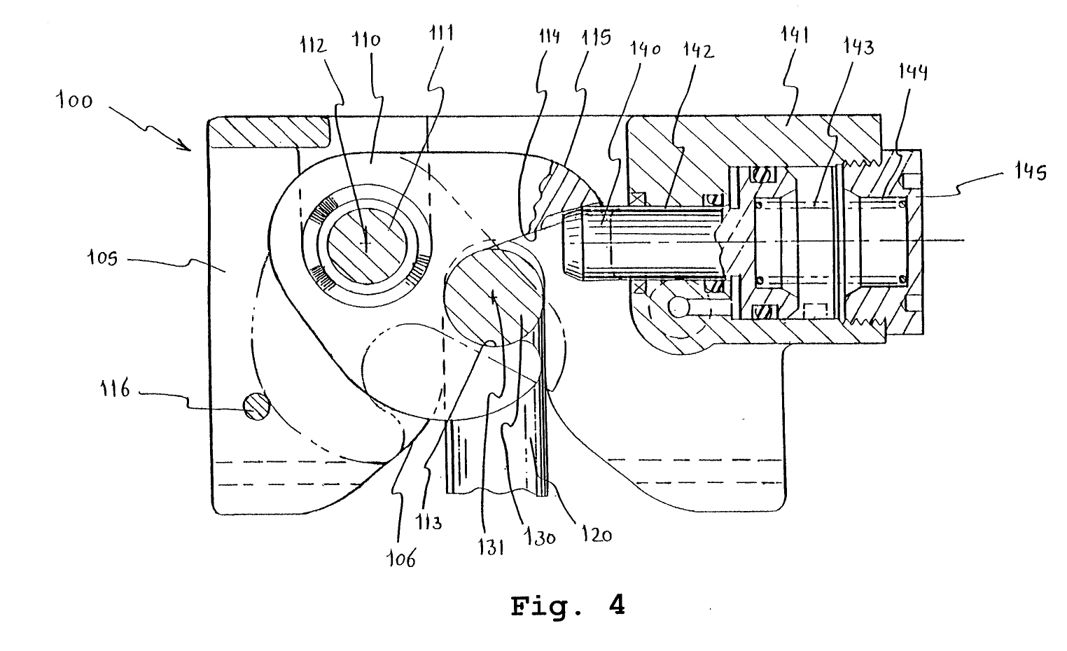

FIG. 4 shows a part of a second preferred embodiment of a tilting mechanism 100 according to the present invention. A support 105 having a V-shaped guide 106 is fixed on the underside of a cab (not shown) and comprises a substantially U-shaped locking hook 110 having a hook surface 113, a projection guide surface 114 and a pin guide surface 115. The locking hook 110 is bearing-mounted on a pin 111 connected in a fixed manner to the support 105. The central axis 112 of the pin 111 is substantially parallel to the central axis 131 of a projection 130 which is fitted on the top end of a piston rod 120.

The support 105 also comprises a stop pin 116, which is fixed to the support 105 and forms a stop for the locking hook 110 when the latter is in the initial position, in other words, before the fitting of the tilting mechanism 100 on the cab.

A retaining pin 140 is situated in a housing 141 that is disposed in the support 105. The retaining pin 140 can be displaced inside a bore 142 in the housing 141. The housing 141 also comprises a coil spring 143, which presses against the retaining pin 140 at one end and at the other end is confined in a bore 144 in a retaining piece 145 screwed on the housing 141.

The initial position of the locking hook 110 is indicated by means of dotted lines in FIG. 4. In this position the locking hook 110 rests against the stop pin 116 and presses the retaining pin 140 under the influence of the coil spring 143 against the pin guide surface 115. When the support 105 is moved in the direction of the piston rod 120 during the fitting of the tilting mechanism 100 on the cab, the guide 106 slides over the projection 130 and the locking hook 110 goes with its projection guide surface 114 against the projection 130. Under the influence of the weight of the cab on which the support 105 is fixed, the pin guide surface 115 glides along the retaining pin 140, and the latter is displaced against the action of the coil spring 143 inside the bore 142. In this process the projection guide surface 114 is pressed in the direction of the cab, with the locking hook 110 rotating about the pin 111, and the hook surface 113 going into engagement with the projection 130. As soon as the pin guide surface 115 passes the retaining pin 140, the hook surface 113 is in full engagement with the projection 130 and the retaining pin 140 is pushed over the projection guide surface under the influence of the action of the coil spring 143.

It will be clear to the person skilled in the art that the scope of the present invention is not limited to the examples discussed above, but that various alterations and modifications thereof are possible without deviating from the scope of the invention as defined in the appended claims.

A permanent coupling, a permanent engagement or a permanent connection are terms meant to convey a coupling, an engagement or a connection which cannot become disconnected in normal circumstances, for example during driving of a vehicle or tilting of a vehicle cab. Such a coupling, engagement or connection can, however, be disconnected in an action for that purpose, which is performed, for example, in a workshop using certain tools.

What is claimed is:

1. Tilting mechanism for making the cab of a vehicle tilt relative to the chassis of the vehicle, comprising:
an extending and retracting actuator;
a first coupling means, intended for coupling the actuator to the cab; and a second coupling means, intended for coupling the actuator to the chassis; wherein at least one of the first coupling means and the second coupling means comprises a fixing means having a first fixing part and a second fixing part, the first fixing part and the second fixing part being designed to go into a permanent engagement with each other as a result of the first fixing part and the second fixing part being brought together during the assembly of the vehicle.

2. Tilting mechanism according to claim 1, wherein the first fixing part and the second fixing part are designed to go into a permanent engagement with each other as a result of the cab of the vehicle and the chassis of the vehicle being brought together during the assembly of the vehicle.

3. Tilting mechanism according to claim 1, wherein the first fixing part and the second fixing part are designed to go into a permanent engagement with each other as a result of the actuator being extended during the assembly of the vehicle.

4. Vehicle having a cab and a chassis, in which the cab is tiltable relative to the chassis, comprising:
a tilting mechanism having an extending and retracting actuator;
a first coupling means, intended for coupling the actuator to the cab; and a second coupling means, intended for coupling the actuator to the chassis, wherein at least one of the first coupling means and the second coupling means comprises a fixing means having a first fixing part and a second fixing part, the first fixing part and the second fixing part being designed to go into a permanent engagement with each other as a result of the first fixing part and the second fixing part being brought together during the assembly of the vehicle.
